(19) United States
(12) Patent Application Publication
(10) Pub. No.: US 2005/0216845 A1
(43) Pub. Date: Sep. 29, 2005

(54) Utilizing cookies by a search engine robot for document retrieval

(76) Inventor: Jason Wiener, Chicago, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 10/977,136

(22) Filed: Oct. 29, 2004

Related U.S. Application Data
(60) Provisional application No. 60/516,497, filed on Oct. 31, 2003.

(51) Int. Cl. G06F 17/00

(52) U.S. Cl. 715/745; 715/501.1; 707/3

(57) ABSTRACT

The present invention in one embodiment includes a computer implemented method for performing a crawl of a web-site, that contains linked web pages. The invention includes retrieving a cookie corresponding to the root web page and retrieving a web page that is linked to said root web page by utilizing said cookie corresponding to said root web page to gain access to said hyperlinked web page.

### CROSS-RELATED TO OTHER APPLICATIONS

This application claims benefit of U.S. Provisional Application 60/516,497 filed on Oct. 31, 2003.

### FIELD OF THE INVENTION

The present invention relates generally to the retrieval of web pages, more particularly those requiring web browsers to accept cookies from a web server and then present cookies back to the web server in order to retrieve documents from the web server and how an Internet search engine crawler (referred to as a “bot”) can access these pages using cookies.

### DESCRIPTION OF RELATED ART

The World Wide Web (“web”) contains a vast amount of information not currently accessible by prior art search engines due to the fact that search engine bots are incapable of identifying and presenting the appropriate credentials to gain access to web servers requiring cookies for interaction. Web servers use cookies, in many cases, to maintain critical user information so that it can function correctly. A web server is often made up of multiple pages that are linked to each other. When a user is visiting the web server, specific user information is transferred back and forth and stored on the user's computer for future access by the web server. The information is stored in what is widely known and referred to as cookies. When a user has cookies stored on their computer, the web server will often permit the user to access secondary pages. However, if the cookie has been erased by the user or the user does not have the cookie, then the web server will often transfer a user to a default page, typically the web site's initial or front page. Thus, even if the user has a specific and direct link to a secondary page, the user will be tranferred to the initial page if the user does not have the cookie that permits the direct access.

A web “crawl” consists of retrieving pages from a desired web server, saving the web pages in a repository, cataloging hyperlink references from each page retrieved and adding those hyperlinks to a retrieval queue for retrieval. Once the queue has been cleared, the crawl has been completed. Since current web crawlers (“bots”) do not accept and present cookies, they are incapable of accessing, retrieving and cataloging a target web site's documents (secondary pages) for use in search engine indexes, when those documents or secondary page requires a cookie for access. As such it is an object of the invention to provide a web crawler that employs cookies such that additional and secondary pages are available through a search engine.

### SUMMARY OF THE INVENTION

The method and purpose of the invention is to enable bots to employ cookies in conjunction with the document retrieval applications running during a search engine crawl. The cookies are most commonly delivered, but not always, via the header of a returned document. By utilizing cookies, a bot can gain access, retrieve and repose publicly available information on the Internet previously unavailable to the search engine crawler or bot. In one aspect of the invention, a computer implemented method for performing a crawl of a web-site, that contains hyperlinked web pages, is provided. The method will retrieve a web page, defined by the web-site, and retrieve a cookie corresponding to the web page. The method will index the web page on a database and index the cookie corresponding to the web page on a database. The method will retrieve a second web page that is linked or hyperlinked to the web page by utilizing the cookie corresponding to the web page to gain access to the linked web page.

### BRIEF DESCRIPTION OF THE DRAWINGS

The accompanying drawings, incorporated herein and constitute part of this specification, illustrates one embodiment of the invention and, together with the description, explain the invention. In the drawings,

FIG. 1 is a diagram illustrating an exemplary system in which concepts consistent with the present invention may be implemented;

FIG. 2 is a flow chart illustrating an exemplary system in which the invention may function in conjunction with a search engine crawler application

FIG. 3 is a flow chart illustrating, in additional detail, methods consistent with the present invention for identifying and cataloging cookie information for a target web site.

FIG. 4 is a flow chart illustrating methods consistent with the present invention for retrieving stored cookies and presenting the cookies back to a target web site's server through a bot;

FIG. 5 is a flow chart illustrating methods consistent with the present invention for identifying, cataloging and storing cookies from a target web site; and

### DETAILED DESCRIPTION

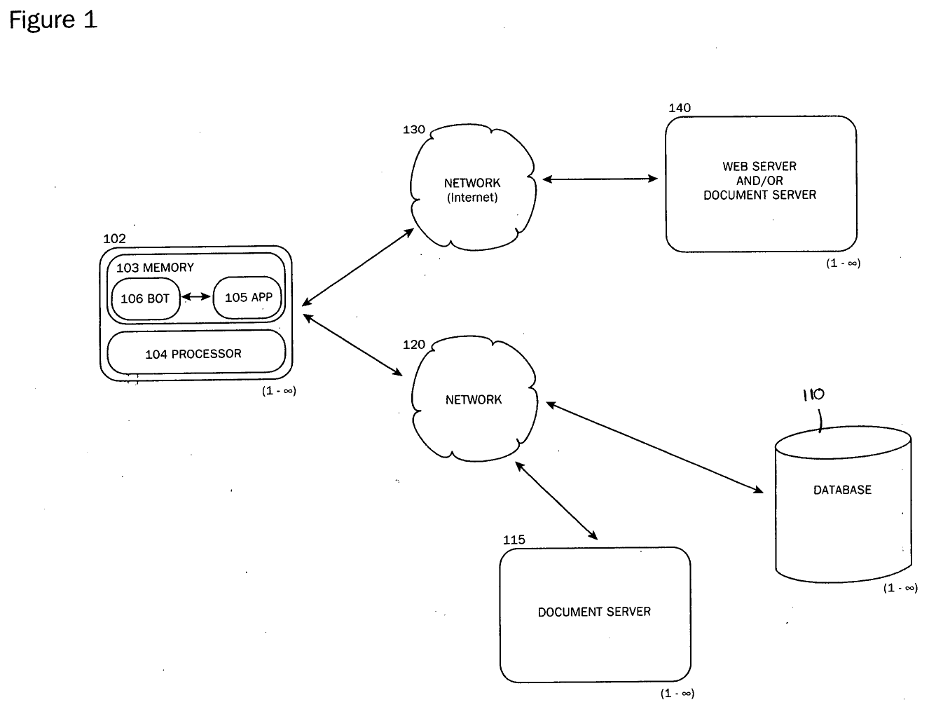

A generalized computer network diagram, consistent with the present invention is illustrated in FIG. 1. The invention consists of an application 105, written in a computer-readable language, executed in memory 103 on any number of computers or servers 102 that are used in conjunction with search engine crawling practices. The application 105 is therefore a search engine used in connection with a crawler, spider, or bot 106 in accordance with the present invention discussed in greater detail below. The application/bot is performed on a computer 102 that may be logically connected to a private local area network 120 containing any number of document servers 115 and/or database servers 110. The computer 102 is also logically connected to a public network 130 (such as the Internet) containing any number of document servers 140. FIG. 1 illustrates the invention as being executed in memory 103 in conjunction with the computer 102 running the search engine bot 106. The computer 102 can, but isn't required to, run the search engine bot application 106 locally. In cases where the bot 106 is not executed locally, the application 105 can be accessed over networks 120 or 130. Within the servers 110, 115, or 140 details about cookies used by the target web site or documents are stored. These cookie details may be stored in database applications including (but not limited to) MySQL, Oracle, Microsoft SQL Server, or Filemaker Pro, or as static documents formatted as (but not limited to) text, XML, or HTML.

The search engine application 105, as well known in the prior art, creates listings of web pages automatically. Typically, the bot 106 will visit a web site, read it, save it it and follow links to other secondary pages in the web site. The bot 106 will automatically return to the site on a regular basis to look for changes or new pages. The search engine application 105 will retrieve the information obtained by the bot 106 and create an index or catalog, which contains a copy of every web page the bot 106 locates. The index or catalog is stored on a database 110 directly accessible by the search engine application 105. As the original web site is updated, the index will change. The search engine application 105 when accessed by a user sifts through the index to find matches to the specific search request. The matches are returned to the user with the link to the actual web page or document. As such, when the user selects a link from the search engine, the user is redirected to the web page that matches to the stored index page.

Problems arise, as mentioned above, when cookies are involved. Since search engine bots 106 do not use cookies, the bots are often restricted from entering the linked pages or the links stored on the index will not accurately open. The search engine bots 106 thus are not capable of indexing secondary or linked pages, limiting the available index to the default or initial web page or other secondary pages which do not require cookies for access.

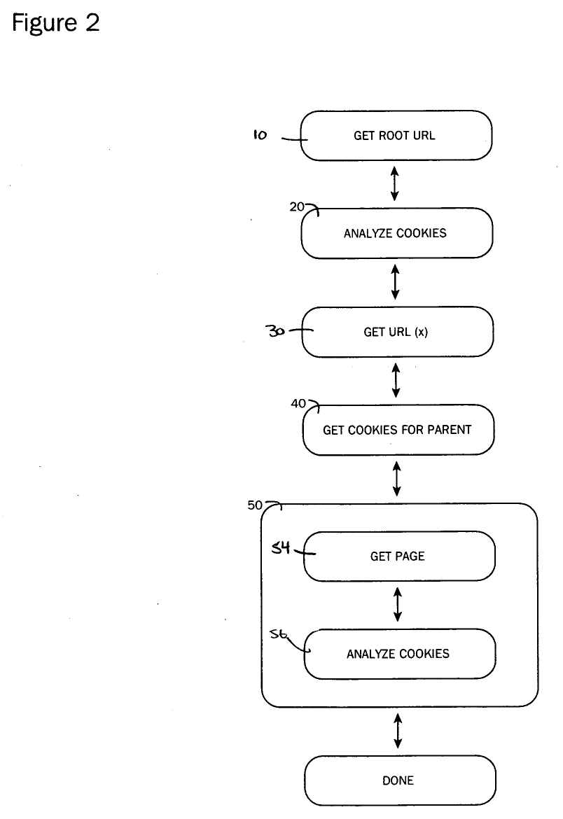

FIG. 2 generally represents an application context in which the invention may be utilized. If the search engine has not previously indexed any page on the target web site, the invention will perform an initial analysis of the root page of the web site, Step 10. This may require automatically truncating the uniform resource indicator (“URI”) to its root URI. For example, if the initial crawl is started on the target web site URI www.dipsie.com/bot.html the invention will truncate the URI to the root domain, www.dispsie.com. In the next step the invention will analyze any cookies on the root page, Step 20. The analysis is referred to herein as an audit of the cookies. This function discussed in greater detail below, examines the cookies and adds and/or updates information relating to the cookie to the database 110, that is later used by the bot 106. An application is designed to strip the cookies of its relevant information or attributes. Since cookies are uniformly defined the information contained therein is relatively easy to read and dissect.

In the crawl processes, as mentioned above, the bot 106 will be instructed to retrieve a target document or will be given a specific URL for the search engine index. As such, the bot 106 will return to the target web site (in the example above the target website was www.dipsie,com/bot.html), Step 30. Prior to initiating the retrieval request, the bot 106 will access the database 110 and retrieve the cookies associated with the initial root URL or initial web page from where the document is being retrieved, Step 40. This is done because the targeted web page has been linked to the stored cookie. Once the cookies have been retrieved from the database 110, they are included in the bot's request for the target document. The bot 106 uses the retrieved cookie in its request to gain access to the target document. In Step 50, the bot 106 retrieves the target page, Step 54, from the web server. The application 105 is then able to index and save the target page. In addition, the bot 106 also retrieves the target page's header information (which typically contains the cookie) and sends it to the application 105 for a further cookie audit, Step 56. As discussed herein below, the header information of a web page contains cookies. Within the cookie audits, the invention will identify cookies associated with the target document and add or update the database 110 on an ad hoc basis. The cookies obtained from the target page can be used by the bot to gain access to other secondary pages linked from the target page. The links in the retrieved page can be stripped during the indexing by the application 106 and provided to the bot with the relevant cookie information for additional deeper crawls, thereby permitting the bot to dig deeper into a web site and retrieve much more web pages and information then previous prior art crawls.

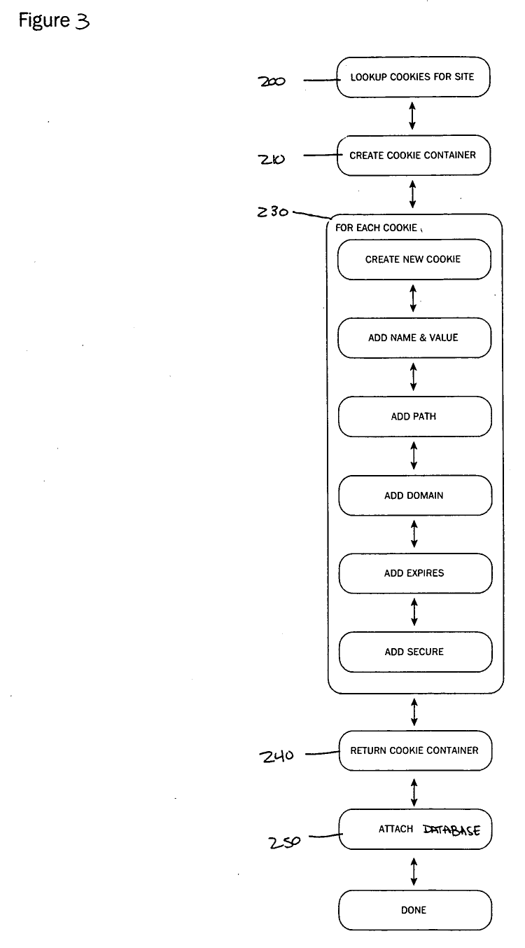

Once the initial cookie audit function has been completed, the bot will begin a cycle of indexing the target web site until all pages identified to be indexed in the crawl have been indexed, as such Step 50 is repeated until the crawl is finished. For each page being indexed, the invention will first retrieve all cookie data for the target web site from the database, Step 200, FIG. 3. As mentioned above, the cookie data is obtained from the web page header information. Next, the invention analyzes the cookie by cataloging the cookie's attributes and then may create a container on the database 110 to store the cookie data returned from the web site 210. For each cookie returned to the database 110, the invention will create an entry in the container that stores details of the cookie data, such as name, path, domain, expires and secure, Step 230.

The name is a value string of a sequence of characters excluding semi-colon, comma and white space. This is the only required attribute on the Cookie header. The Path attribute is used to specify the subset of URLs in a domain for which the cookie is valid. If a cookie has already passed domain matching, then the pathname component of the URL is compared with the path attribute, and if there is a match, the cookie is considered valid and is sent along with the URL request. If the path is not specified, it is assumed to be the same path as the document being described by the header which contains the cookie. The domain attribute of the cookie may be the host name of the server which generated the cookie. A domain attribute of “dipsie.com” would match host names “bot.dipsie.com” as well as “app.bot.dipsie.com”. The expires attribute specifies a date string that defines the valid life time of that cookie. Once the expiration date has been reached, the cookie will no longer valid. If the secure attribute is marked it will only be transmitted if the communications channel with the bot is a secure one. Currently this means that secure cookies will only be sent to HTTPS (HTTP over SSL) servers. If secure is not specified, a cookie is considered safe to be sent over unsecured channels.

Continuing to refer to FIG. 3, once all cookies returned from the database have been attached to the container, the container is returned to the database 110 for future use and updating by the bot 106, Step 240. The cookie container is linked or attached to the web site, such that during future crawls or updates by the bot 106, the bot 106 will grab the cookie container linked to the web site.

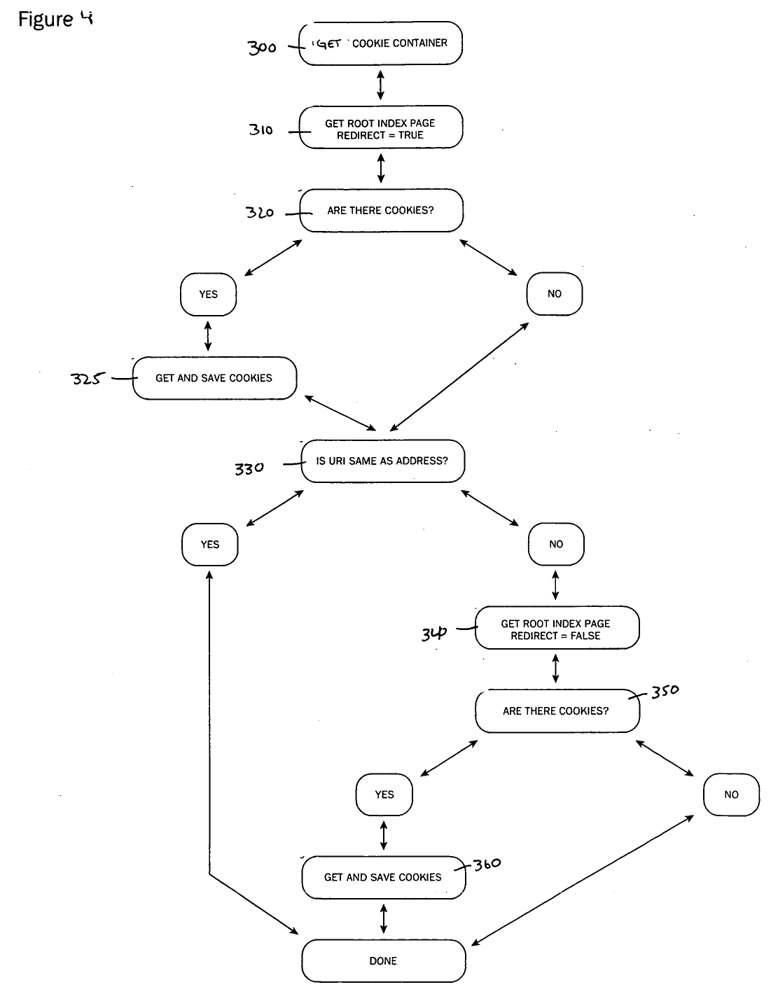

Referring now to FIG. 4, once the initial cookie audit is complete the bot 106 will systematically return to the web site to update the container by cataloging new cookies and updating preexisting cookies. The bot 106 will retrieve the cookie container on the database linked to the web site, step 300. The bot 106 examines the URI (Uniform Resource Indicator) for the page that was returned in response to the crawl request which was made for the targeted document, Step 310. Once the non-redirected page has been returned, and if cookies exist on the retrieved page, the invention performs a cookie audit (described above) appending the database as needed and returning the cookies for the target site to the bot.

If the URI of the page returned is not the same as the URI of the page requested, the bot 106 was redirected to another web page. The bot 106 grabs the header information on the returned page and investigates as to whether there are cookies, Step 320. The cookies are then added to the cookie container and linked to the returned page, Step 325. The bot 106 may then make another request for the target page and check to see if the URI of the returned page is the same as the requested page, Step 330. If it is the target page, the page is indexed and any cookies on the returned requested page cataloged. If the URI is not the same, than the bot 106 was redirected again, Step 340. The bot 106 then checks and updates the cookies, Step 350 and Step 360. This may be repeated until the returned requested page matches the targeted page.

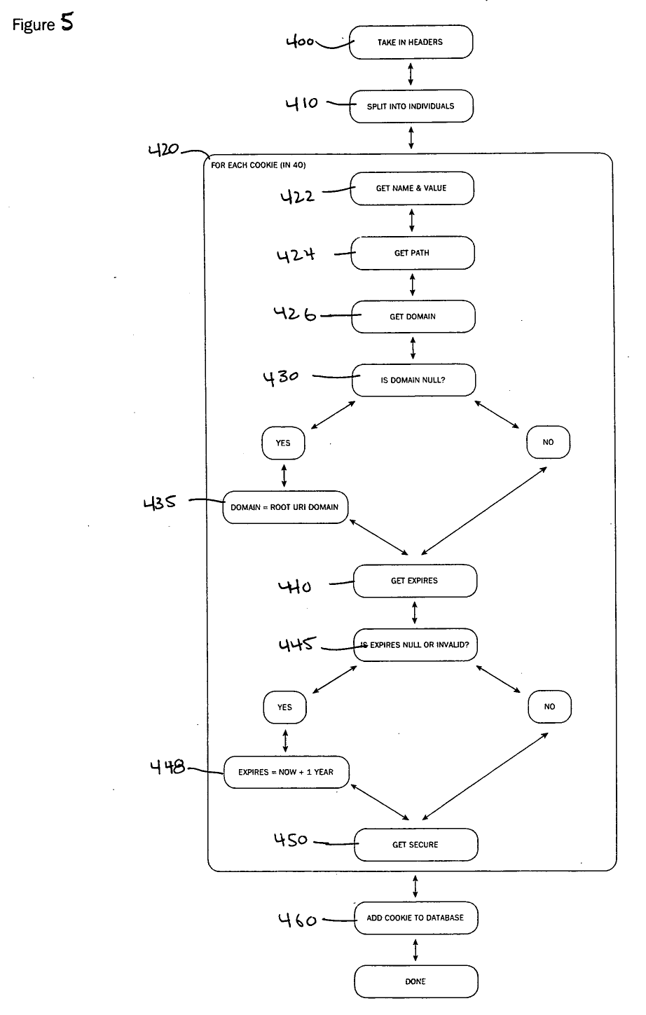

Referring now to FIG. 5, each time a bot begins crawling a web site, the bot will access the database 110 and retrieve the cookies associated to the web site to perform a preliminary cookie audit of the target web site. To do this, the method of the invention retrieves a page for the website, which may be the root page. Called by an application, the cookie audit is a sub function residing within the application 105 and along with bot 106. The cookie audit function is provided the document header information, Step 400. Specifically the information contained within the set-cookie header key and URI for processing. The cookie audit function then splits the cookies into individual cookies and stores the split cookies into a collection for further analysis 410. In some instances, a cookie header may include numerous cookies. In Step 420, for each cookie, the function then extracts the values for the cookie variables: “name,” Step 422, “path,” Step 424, “domain,” Step 426, “expires,” Step 440, and “secure,” Step 450.

If the variable “domain” does not have a value, Step 430, the function will assign the root of the URI for the “domain” variable, Step 435. For example, if the URI was http://www.dipsie.com/bot/sample.html, the function would assign the variable “domain” the value of root domain (i.e. www.dipsie.com).

The function would also check the value of the variable “date”, Step 445. If the value of the expires attribute is not a valid date or is empty the function assigns the “date” variable a value of the date one year from the current date, Step 448.

Once all variables have been assigned values, the function will add the cookie to database or the cookie container for the target web site, Step 460. If a cookie with the same name currently exists in the database, the function will update the cookie data in the database with the newly cataloged cookie information.

From the foregoing and as mentioned above, it will be observed that numerous variations and modifications may be effected without departing from the spirit and scope of the novel concept of the invention. It is to be understood that no limitation with respect to the specific embodiments illustrated herein is intended or should be inferred. It is, of course, intended to cover by the appended claims all such modifications as fall within the scope of the claims.

1. A computer implemented method for performing a crawl of a web-site that contains a root web page and web pages linked to said root web page, the method comprising:
retrieving a cookie corresponding to said root web page; and
retrieving a web page that is linked to said root web page, which was previously inaccessible to the crawl, by utilizing said cookie corresponding to said root web page to gain access to said linked web page.

2. The computer implemented method of claim 1 further comprising retrieving and indexing said root web page on a database and cataloging said cookie corresponding to said root web page on a database.

3. The computer implemented method of claim 2 wherein the step of retrieving a root web page and retrieving a cookie corresponding to said root web page, further defined as a first cookie corresponding to said root web page, includes:
determining if a second cookie corresponding to said root web page preexists on said database, where upon said preexisting second cookie is compared to said first cookie and said preexisting second cookie is updated when information contained in said first cookie is different from information contained in said preexisting second cookie.

4. The computer implemented method of claim 1 further comprising:
retrieving and cataloging a cookie corresponding to said linked web page.

5. The computer implemented method of claim 4 further comprising:
performing a subsequent crawl of said linked web page by presenting said cookie corresponding to said linked web page such that direct access may be granted to said linked web page.

6. The computer implemented method of claim 5, wherein during said subsequent crawl of said linked web page, a web page is returned to said crawl, the method includes: comparing a Uniform Resource Indicator associated to said returned web page to said linked web page to identify if said returned web page is the linked web page.

7. The computer implemented method of claim 6, wherein when said returned web page is not the linked web page,
retrieving said returned web page and retrieving and analyzing a cookie corresponding to said returned web page; and
re-crawling said linked web page and using said cookie corresponding to said returned web page to gain access to said linked web page.

8. The computer implemented method of 1 further comprising:
creating a container storage area in the database;
cataloging and storing cookies corresponding to a web site, which may contain more than one web page, in said container; and
linking each cookie to its corresponding web page associated to said web site;
linking said container to said web site, wherein during subsequent crawls, which retrieves cookies,
utilizing said stored cookies to gain access to web pages,
comparing said stored cookies to said retrieved cookies,
updating information in said stored cookies when said information in said stored cookies is different than information in said retrieved cookies, and
adding a cookie to said container if said retrieved cookie does not match any stored cookie.

9. A computer-executable crawler application stored on a computer readable storage medium that is accessible to a server computer coupled to a network that is accessible to a plurality of documents, the application comprising:
executable code for retrieving a first document, from the plurality of documents, and indexing said first document in said storage medium;
executable code for determining whether said first document contains a first cookie and retrieving said first cookie associated to said first document; and
executable code for determining whether said first document is linked to second document and retrieving said second document by presenting said first cookie associated to said first document to gain access thereto.

10. The crawler application according to claim 9 further comprising:
executable code for cataloging and storing said first cookie in said storage medium.

11. The crawler application according to claim 9 further comprising:
executable code for determining whether said second document contains a second cookie and cataloging and storing said second cookie associated to said second document in said storage medium.

12. The crawler application according to claim 10 further comprising:
executable code for re-retrieving the first document and the first cookie and updating said stored first cookie in said storage medium when said stored first cookie is different than said re-retrieved first cookie.

13. The crawler application according to claim 11 further comprising:
executable code for re-retrieving the second document utilizing the stored cookies.

14. A computer system comprising:
a network operatively coupled to the server computer, wherein the network includes a plurality of documents;
a computer readable storage medium operatively coupled to the server computer; and
a computer-executable crawler application stored in the computer readable storage medium, wherein the crawler application, when executed by the server, causes the following acts to be carried out by the server:
retrieving a cookie corresponding to a document, of the plurality of documents; and
retrieving a secondary document, of the plurality of documents, that requires a cookie to gain access, that is linked to said document by utilizing said cookie corresponding to said document to gain access to said linked secondary document.

15. A computer implemented method for performing a crawl of a web-site that contains a first web page and a secondary web page linked to said first web page, wherein the secondary web page requires a cookie corresponding to the first web page in order to access said secondary web page, the method for performing the crawl comprising:
retrieving said cookie corresponding to the first web page; and
retrieving the secondary web page that is linked to said first web page by presenting to the web site said cookie corresponding to said first web page thereby gaining access to said secondary web page.

16. The computer implemented method of claim 15 further comprising:
retrieving a web page believed to be corresponding to said secondary web page;
comparing a URL defined by said retrieved web page to a URL defined by said secondary web page and when said URL of said retrieved web page is different then said URL of said secondary web page, retrieving and indexing a cookie corresponding to said retrieved web page; and
re-crawling said secondary web page by presenting said cookie corresponding to said retrieved web page.
